(19) United States
(12) Patent Application Publication
(10) Pub. No.: US 2012/0100257 A1
(43) Pub. Date: Apr. 26, 2012

(54) Omega-3 Fatty Acid Enriched Beverages

(75) Inventors: Beata E. Lambach, St. Louis, MO (US); David Welsby, University City, MO (US); Seok Lee, Edwardsville, MO (US); Candice Lucak, St. Louis, MO (US)

(73) Assignee: SOLAE, LLC, St. Louis, MO (US)

(21) Appl. No.: 13/381,418

(22) PCT Filed: Jun. 29, 2010
(86) PCT No.: PCT/US10/40469

§ 371 Date: Dec. 29, 2011

Related U.S. Application Data
(60) Provisional application No. 61/221,954, filed on Jun. 30, 2009.

(51) Int. Cl. A23L 2/52; A23L 2/66; A23C 9/152; A23L 2/44; A23F 3/00; C12G 3/00; A23L 2/38; A23L 2/02; A23D 9/007; A23F 5/00

(52) U.S. Cl. 426/66; 554/224; 426/598; 426/585; 426/595; 426/597; 426/592; 426/541; 426/546; 426/542; 426/543; 426/442; 426/330.3

(57) ABSTRACT

The present invention relates to beverage compositions and methods for producing beverage compositions with a quantity of omega-3 fatty acids (n-3 PUFAs). Specifically, the beverage compositions comprise a quantity of stearidonic acid (SDA) enriched soybean oil that imparts improved nutritional quality with a quantity of n-3 PUFAs, but retains the mouthfeel, flavor, odor, and other sensory characteristics associated with typical beverage compositions.

### FIELD OF THE INVENTION

The present invention generally relates to a beverage composition with a quantity of polyunsaturated fatty acids and the method of making such a composition. More specifically, the invention is to a beverage composition that comprises a quantity of stearidonic acid (SDA) enriched soybean oil and the method of making the composition. The beverage composition possesses improved nutritional qualities through the use of the SDA enriched soybean oil to produce beverages with a quantity of omega-3 polyunsaturated fatty acids (n-3 PUFAs).

### BACKGROUND OF THE INVENTION

Recent dietary studies have suggested that certain types of fats are beneficial to body functions and improved health. The use of dietary fats is associated with a variety of therapeutic and preventative health benefits. Current research has demonstrated that the consumption of foods rich in n-3 PUFAs and especially omega-3 long chain polyunsaturated fatty acids (n-3 LCPUFAs), such as eicosapentaenoic acid (EPA; 20:5, n-3) and docosahexaenoic acid (DHA; 22:6, n-3) decreases cardiovascular death by positively impacting a number of markers, such as decreasing plasma triglycerides and blood pressure, and reducing platelet aggregation and inflammation. Typically, n-3 PUFAs, including n-3 LCPUFAs are derived from plant or marine sources. Marine oils, found in fatty fish, are an important dietary source of the n-3 PUFAs such as EPA, and DHA. While fatty fish may be the best source of these omega-3 fatty acids, many individuals do not like the taste of such seafood, do not have ready access to such seafood, or cannot afford such seafood. One solution is to supplement the diet with cod liver oil or fish oil capsules, but many people find the large capsules (ca. 1 g each) difficult to consume, and so this solution has limited compliance. Another solution is to add n-3 PUFAs rich fish oils directly to foods and beverages.

A challenge with the latter approach is to provide the benefits of n-3 PUFAs without imparting any offending fish flavors or fish odors, which develop as a consequence of lipid oxidation. Currently, beverages may be found in the marketplace that include a quantity of n-3 PUFAs derived from flax, used either as full-fat flour or as oil, both providing α-linolenic acid (ALA; 18:3 n-3), marine based sources, such as fish oil, or from land-based algal sources produced by fermentation, typically DHA in this case. These ingredients contribute a significant quantity n-3 PUFAs, but these sources of n-3 PUFAs produce unpleasant off flavors (flax oil) or are typically unstable and are especially susceptible to rapid oxidation. Consequently, in current products containing n-3 PUFAs from these sources, the levels of inclusion are very low and generally insufficient to have the desired health impact found at higher dietary levels of use. Because of the generally high temperature and other extreme processing conditions, the beverage compositions must endure the unstable n-3 PUFAs found in the marine or algal derived sources produce highly undesirable fishy or painty off-flavors and odors when developing/processing/storing the beverage compositions. Therefore, there is a need for a process and the resultant beverage compositions that include a physiologically significant quantity of n-3 PUFAs, that when included with beverage compositions does not produce fishy or unacceptable flavors or odors in the final end beverage product.

Additionally, it is possible to consume certain plant derived food products or supplements that contain n-3 PUFAs. These plant derived n-3 PUFAs, often consist of α-linolenic acid (ALA; 18:3, n-3). ALA is susceptible to oxidation which results in painty off-odors. Moreover, the bioconversion of ALA to n-3 LCPUFAs (specifically EPA) is relatively inefficient. Thus, there is a need for forms of n-3 PUFAs that provide the benefits of ready conversion to n-3 LCPUFAs.as well as good oxidative stability in foods. Additionally, there is a need for a process that includes a quantity of stable n-3 PUFAs that are readily metabolized to n-3 LCPUFAs and the resultant beverages. As previously stated, the plant derived n-3 PUFAs (ALA) are also susceptible to oxidization and can impart offensive painty odors and tastes when exposed to extreme processing steps and the processing environment. Therefore, there is a need for a process and resultant beverage compositions, such as smoothies, dairy drinks, juices and other beverages that include a quantity of n-3 PUFAs, that are stable, and do not impart fishy or painty odors or tastes due to oxidation of the n-3-PUFAs during the processing steps, while being transported, and/or stored before consumption.

### SUMMARY OF THE INVENTION

The present invention is a beverage composition that includes a quantity of stearidonic acid (SDA) enriched soybean oil. The SDA enriched soybean oil contains n-3 PUFAs that when incorporated into beverages, provides a clean flavor, longer shelf-life stability, minimal oxidation, stability when exposed to extreme processing conditions, and enhanced nutritional qualities when compared to other sources of n-3 PUFAs. Further, the beverage compositions with the SDA enriched soybean oil possess similar taste, mouthfeel, odor, and flavor, and sensory properties when compared to products made from conventional oils, such as soybean oil, but with increased nutritional values.

Additionally, the beverage product may include a quantity of a stabilizing agent such as lecithin. Other stabilizing agents, such as other phospholipids or antioxidants, can be combined with the SDA enriched soybean oil for incorporation into the beverage. The incorporation of the stabilizing agents produces a beverage composition that possesses similar taste, mouthfeel, odor, flavor, and sensory properties when compared to products made from conventional oils, such as soybean oil, but with increased nutritional values, and further has enhanced storage and shelf stability.

Further, the beverage composition may include a quantity of protein such as soy protein, pea protein, milk protein, rice protein, collagen, and combinations thereof. The beverage composition containing protein may include a stabilizing agent.

The present invention is also directed to a method of using SDA enriched soybean oil and a stabilizing agent to produce a beverage composition that has enhanced nutritional qualities but similar taste, mouthfeel, odor, flavor, and sensory properties when compared to a typical beverage composition.

The current invention demonstrates a process, composition, end product, and method of using SDA enriched soybean oil for beverage compositions that possess certain nutritional and beneficial qualities for a consumer and have enhanced storage and shelf stability. But the beverage compositions also have similar taste, mouthfeel, odor, and flavor as that formed in typical beverage compositions desired by consumers.

### DESCRIPTION OF THE FIGURES

FIG. 1 graphically illustrates the sensory profiling of strawberry dairy drink composition flavor, texture, and aftertaste differences at Time 0 based on Soybean Oil and SDA Oil. The black dashed line marks the Recognition Threshold Level.

FIG. 2 graphically illustrates the sensory profiling of strawberry dairy drink composition flavor, texture, and aftertaste differences at 6 Months stored at 25° C. based on Soybean Oil and SDA Oil. The black dashed line marks the Recognition Threshold Level.

FIG. 3 graphically illustrates the sensory profiling of strawberry dairy drink composition flavor, texture, and aftertaste differences at 6 Months stored at 37° C. based on Soybean Oil and SDA Oil. The black dashed line marks the Recognition Threshold Level.

FIG. 4 summarized consumer acceptance ratings for strawberry dairy drink compositions at 4 Months stored at 25° C. prepared with Soybean Oil and SDA Oil.

FIG. 5 summarized consumer acceptance ratings for strawberry dairy drink compositions at 6 Months stored at 25° C. prepared with Soybean Oil and SDA Oil.

FIG. 6 illustrates the SQS Scores of plain soymilk based on Soybean Oil and SDA Oil.

FIG. 7 illustrates the SQS Scores of mixed berry smoothie with Soybean Oil and SDA Oil.

FIG. 8 graphically illustrates the sensory profiling of clinical nutrition beverages flavor and texture differences based on Soybean Oil and SDA Oil at Time 0. The black dashed line marks the Recognition Threshold Level.

FIG. 9 graphically illustrates the sensory profiling of clinical nutrition beverages flavor, texture, and aftertaste differences based on Soybean Oil and SDA Oil at 4 Months. The black dashed line marks the Recognition Threshold Level.

FIG. 10 summarizes consumer acceptance ratings for clinical nutrition beverages prepared with Soybean Oil and SDA Oil.

### DETAILED DESCRIPTION OF THE INVENTION

The present invention relates to a process for producing beverage compositions with an increased nutritional value for consumption by consumers to improve their health. Further, the invention is to beverage compositions with increased nutritional values that include a quantity of n-3 PUFAs but retain the mouthfeel, flavor, odor, and other sensory characteristics of typical beverage compositions that consumers desire.

Use of PUFAs and especially n-3 PUFAs in beverage compositions is typically limited by their lack of oxidative stability. The processing conditions that certain beverage products must undergo, cause n-3 PUFAs to readily oxidize and produce off flavors in the beverage. By using a type of n-3 PUFAs that is oxidatively stable during mixing, processing, and packing phases and during storage, transport and shelf life, a beverage composition is produced that not only retains the mouthfeel, flavor, odor, and other characteristics typical beverage compositions possess, but also has increased nutritional value.

### (I) Compositions

One aspect of the present invention is a beverage composition that comprises a quantity of n-3 PUFAs. The n-3 PUFAs are incorporated into the beverage compositions through the use of SDA enriched soybean oil. In one embodiment the SDA enriched soybean oil is obtained from soybeans that are engineered to produce high levels of stearidonic acid (SDA), such as those described in WO2008/085840 and WO2008/085841. The soybeans can be processed according to the extraction method consistent with those methods described in US Patent Application 2006/0111578 and 2006/0111254. In another embodiment oil obtained from other plant sources with elevated SDA, such as but not limited to Echium spp and blackcurrant oil can be used.

In another embodiment soy flour can be used that is enriched with SDA, either from SDA enriched soybeans or through other processes known in the industry. The SDA enriched soy flour is produced according to typical processes known in the industry, with the SDA enriched soy flour used to replace current soy flour or other flours, and ingredients during the production of the beverage compositions to produce a beverage composition with the desired nutritional characteristics but still retain the mouthfeel, flavor, odor, and other sensory characteristics of typical beverage compositions.

In another embodiment the beverage composition may further include a phospholipid to stabilize the oxidizable material and thus, reduce its oxidation. A phospholipid comprises a backbone, a negatively charged phosphate group attached to an alcohol, and at least one fatty acid. Phospholipids having a glycerol backbone comprise two fatty acids and are termed glycerophospholipids. Examples of a glycerophospholipid include phosphatidylcholine, phosphatidylethanolamine, phosphatidylinositol, phosphatidylserine, and diphosphatidylglycerol (i.e., cardiolipin). Phospholipids having a sphingosine backbone are called sphingomyelins. The fatty acids attached via ester bonds to the backbone of a phospholipid tend to be 12 to 22 carbons in length, and some may be unsaturated. For example, phospholipids may contain oleic acid (18:1), linoleic acid (18:2, n-6), and alpha-linolenic acid (18:3, n-3). The two fatty acids of a phospholipid may be the same or they may be different; e.g., dipalmitoylphosphatidylcholine, 1-stearyoyl-2-myristoylphosphatidylcholine, or 1-palmitoyl-2-linoleoylethanolamine.

In one embodiment, the phospholipid may be a single purified phospholipid, such as distearoylphosphatidylcholine. In another embodiment, the phospholipid may be mixture of purified phospholipids, such as a mix of phosphatidylcholines. In still another embodiment, the phospholipid may be a mixture of different types of purified phospholipids, such as a mix of phosphatidylcholines and phosphatidylinositols or a mixture of phosphatidylcholines and phosphatidylethanolamines.

In an alternative embodiment, the phospholipid may be a complex mix of phospholipids, such as a lecithin. Lecithin is found in nearly every living organism. Commercial sources of lecithin include soybeans, rice, sunflower seeds, chicken egg yolks, milk fat, bovine brain, bovine heart, and algae. In its crude form, lecithin is a complex mixture of phospholipids, glycolipids, triglycerides, sterols and small quantities of fatty acids, carbohydrates and sphingolipids. Soy lecithin is rich in phosphatidylcholine, phosphatidylethanolamine, phosphatidylinositol, and phosphatidic acid. Lecithin may be de-oiled and treated such that it is an essentially pure mixture of phospholipids. Lecithin may be modified to make the phospholipids more water-soluble. Modifications include hydroxylation, acetylation, and enzyme treatment, in which one of the fatty acids is removed by a phospholipase enzyme and replaced with a hydroxyl group. In another embodiment the lecithin could be produced as a byproduct of the oil production from the SDA enriched soybeans, thus producing a product with a portion of the lecithin to be used with the SDA enriched soybean oil.

In yet another alternative embodiment, the phospholipid may be a soy lecithin produced under the trade name SOLEC® by Solae, LLC (St. Louis, Mo.). The soy lecithin may be SOLEC®F, a dry, de-oiled, non-enzyme modified preparation containing about 97% phospholipids. The soy lecithin may be SOLEC®8160, a dry, de-oiled, enzyme modified preparation containing about 97% phospholipids. The soy lecithin may be SOLEC®8120, a dry, de-oiled, hydroxylated preparation containing about 97% phospholipids. The soy lecithin may be SOLEC®8140, a dry, de-oiled, heat resistant preparation containing about 97% phospholipids. The soy lecithin may be SOLEC®R, a dry, de-oiled preparation in granular form containing about 97% phospholipids.

The ratio of the phospholipid to the SDA enriched soybean oil will vary depending upon the nature of the SDA enriched soybean oil and the phospholipid preparation. In particular, the concentration of phospholipid will be of a sufficient amount to prevent the oxidation of the SDA enriched soybean oil. The concentration of the phospholipid will generally range from less than 0.1% to about 65% by weight of the SDA enriched soybean oil. In one embodiment, the concentration of the phospholipid may range from about 2% to about 50% by weight of the SDA enriched soybean oil. In another embodiment, the concentration of the phospholipid may range from about 2% to about 10% by weight of the SDA enriched soybean oil. In an alternative embodiment, the concentration of the phospholipid may range from about 10% to about 20% by weight of the SDA enriched soybean oil. In yet another embodiment, the concentration of the phospholipid may range from about 20% to about 30% by weight of the oxidizable material. In still another embodiment, the concentration of the phospholipid may range from about 30% to about 40% by weight of the SDA enriched soybean oil. In another alternative embodiment, the concentration of the phospholipid may range from about 40% to about 50% by weight of the SDA enriched soybean oil. In another embodiment, the concentration of the phospholipid may range from about 15% to about 35% by weight of the SDA enriched soybean oil. In another embodiment, the concentration of the phospholipid may range from about 25% to about 30% by weight of the SDA enriched soybean oil.

The beverage compositions may comprise at least one additional antioxidant that is not a phospholipid or a lecithin. The additional antioxidant may further stabilize the SDA enriched soybean oil. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., lonox 100), 2,4-(tris-3′,5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Preferred antioxidants include tocopherols, ascorbyl palmitate, ascorbic acid, and rosemary extract. The concentration of the additional antioxidant or combination of antioxidants may range from about 0.001% to about 5% by weight, and preferably from about 0.01% to about 1% by weight.

The beverage composition may include a quantity of a protein such as soy protein, pea protein, milk protein, rice protein, collagen, and combinations thereof. The beverage composition containing protein may also include a stabilizing agent.

### (II) Method of Using and Processes for Forming the Compositions

Production of the n-3 PUFAs enriched beverage compositions is accomplished by replacing an amount of the typical soybean oil used as an ingredient in beverage compositions with the SDA enriched soybean oil. In another embodiment SDA enriched soybean oil can either replace part or all of the existing fats in an application, or can be added additionally to those products that are naturally or formulated to be, low in fat. In one embodiment, the SDA enriched soybean oil will replace all the fat or soybean oil used to produce the desired beverage. In an alternative embodiment, the SDA enriched soybean oil will replace an amount of the fat or soybean oil used in the beverage to produce an end product that contains a sufficient amount of n-3 PUFAs as recommended by the industry. The general consensus in the omega-3 research community is for a consumer to consume around 400-500 mg/day of EPA/DHA equivalent (Harris et al., (2009) J. Nutr. 139:804S-819S). Typically a consumer will consume four (4) 100 mg/serving per day to ultimately consume 400 mg/day.

The beverage compositions are generally formed dependent on the desired end product. The beverage compositions are produced according to standard industry recipes except the fat or oil ingredient typically used is partially or totally replaced with the SDA enriched soybean oil. The amount of SDA enriched soybean oil used will vary from 1% to 100% and is dependent on the end product and the nutritional value or amount of n-3 PUFAs desired in the end product. In one embodiment 5% of the fat or oil used in a typical beverage composition is replaced with the SDA enriched soybean oil. In another embodiment 10% of the fat or oil used in a typical beverage composition product is replaced with the SDA enriched soybean oil. In another embodiment 25% of the fat or oil used in a typical beverage composition is replaced with the SDA enriched soybean oil. In another embodiment 50% of the fat or oil used in a typical beverage composition is replaced with the SDA enriched soybean oil. In another embodiment 75% of the fat or oil used in a typical beverage composition is replaced with the SDA enriched soybean oil. In another embodiment 90% of the fat or oil used in a typical beverage composition is replaced with the SDA enriched soybean oil. In another embodiment 95% of the fat or oil used in a typical beverage composition is replaced with the SDA enriched soybean oil. In another embodiment 100% of the fat or oil used in a typical beverage composition is replaced with the SDA enriched soybean oil.

In another embodiment an amount of a stabilizing agent, such as a phospholipid, is added to the beverage composition. In one embodiment, the phospholipid is a lecithin and is combined with the SDA enriched soybean oil, the concentration of the lecithin in the beverage composition is from less than 0.1% to about 65% by weight of the SDA enriched soybean oil, and more typically, from about 15% to about 35% by weight of the SDA enriched soybean oil. In another embodiment, the concentration of the lecithin in the beverage composition is from about 25% to about 30% by weight of the SDA enriched soybean oil. In another embodiment an amount of SDA enriched soybean oil can be added in addition to the fat or oil typically used in the beverage composition.

In a further embodiment a quantity of protein is added to the beverage composition. The protein can be any protein known to work in beverages including but not limited to soy protein, pea protein, milk protein, rice protein, collagen, and combinations thereof. Soy proteins that can be incorporated in the beverage include soy protein isolate, soy protein concentrate, soy flour, and combinations thereof.

In another embodiment the beverage composition will include an amount of an ingredient (basic or acidic) to create a beverage with a pH range from less than 2 to greater than 8. The basic or acidic ingredients can be any food grade ingredient currently used in the industry. After including an amount of the SDA enriched soybean oil and the phospholipids, the beverage mixture is then processed according to typical industry recipes to produce the beverage compositions.

### (III) Food Products

A further aspect of the present invention is beverage compositions with n-3 PUFAs incorporated and increased nutritional values which retain the mouthfeel, flavor, odor, and other sensory characteristics of typical beverage compositions. The beverage compositions will vary depending on the desired end product, but can include, and are not limited to, dairy, fruit, soy, vegetable, and other beverage products. The beverage can be a cloudy beverage, clear beverage, or substantially clear beverage.

In one embodiment, the beverage may be a substantially cloudy beverage such as a meal replacement drink, a protein shake, a chai drink, a dairy based drink, a drinkable yogurt, soy creamers, a smoothie, a coffee-based beverage, non-dairy based carbonated beverages (such as soda pop and carbonated water), a nutritional supplement beverage, a medical nutrition beverage, a pediatric nutritional drink, a clinical nutrition liquid, an alcohol based cream liqueur, or a weight management beverage.

In another embodiment, the beverage may be a ready-to-drink (RTD) beverage. Non-limiting examples of the beverage can include a substantially clear beverage such as a juice beverage, bottled water, a fruit flavored beverage, a carbonated beverage, isotonic beverages, energy beverages, a sports drink, a nutritional supplement beverage, a weight management beverage, RTD acidic beverages, RTD neutral beverages, or an alcohol-based fruit beverage. In another embodiment the beverage can be a combination of a dairy and juice based product. In another embodiment the beverage can be a combination of a soy and juice based product. In a further embodiment the beverage can be a combination of a soy and dairy based product.

In another embodiment the product may be a dry blended beverage or powder. The dry blended beverage will have a pH range of 2 to 8.

In another embodiment, the beverage composition can be a liquid refrigerated or liquid shelf stable beverage. Including but not limited to soy milk beverages, soy juice refresher beverages, soy milk shake beverages or soy smoothie beverages. Wherein the beverage contains 15% to 100% of its protein from soy, 14 grams or less of soy protein per 8 ounce serving and/or fortified with less than 10 vitamins or minerals. The soy beverage may also include any additional ingredients typically used in the industry.

The edible material in the beverage composition may include but is not limited to fruit juice, sugar, milk, non-fat dry milk powder, caseinate, soy protein concentrate, soy protein isolate, whey protein concentrate, whey protein isolate, isolated milk protein, chocolate, cocoa powder, coffee, tea, or combinations thereof. The beverage composition may further comprise sweetening agents (such as glucose, sucrose, fructose, maltodextrin, sucralose, corn syrup, honey, maple syrup, stevia, etc.), flavoring agents (e.g., fruit flavors, chocolate flavors, vanilla flavors, etc), emulsifying or thickening agents (e.g., lecithin, carrageenan, cellulose gum, cellulose gel, starch, gum, arabic, xanthan gum, and the like); stabilizing agents, lipid materials (e.g., canola oil, sunflower oil, high oleic sunflower oil, fat powder, etc.), preservatives (e.g., potassium sorbate, sorbic acid, and so forth), antioxidants (e.g., ascorbic acid, sodium ascorbate, etc.), coloring agents, vitamins, minerals, probiotics, omega-3 fatty acids, sterols, fibers, and combinations thereof.

### DEFINITIONS

To facilitate understanding of the invention several terms are defined below.

The term “conventional beverage” refers to a beverage that contains no SDA enriched soybean oil.

The term “N-3 PUFAs” refers to omega-3 polyunsaturated fatty acids and includes omega-3 long chain polyunsaturated fatty acids and n-3 LCPUFAs.

The terms “stearidonic acid enriched soybean oil”, “SDA enriched soybean oil”, and “SDA oil” refer to soybean oil that has been enriched with stearidonic acid.

The term “milk” refers to animal milk, plant milk, and nut milk. Animal milk is a white fluid secreted by the mammary glands of female mammals consisting of minute globules of fat suspended in a solution of casein, albumin, milk sugar, and inorganic salts. Animal milk includes but is not limited to milk from cows, goats, sheep, donkeys, camels, camelids, yaks, water buffalos. Plant milk is a juice or sap found in certain plants and includes but is not limited to milk derived from soy, and other vegetables. Nut milk is an emulsion made by bruising seeds and mixing with a liquid, typically water. Nuts that can be used for milk include but are not limited to almonds and cashews.

The term “milk protein” refers to any protein contained in milk as defined above, including any fractions extracted from the milk by any means known in the art. Milk protein further includes any combinations of milk proteins.

The term “SQS” is a Difference-from-Control Test procedure designed to provide both qualitative and directional quantitative differences between a Control sample and test sample(s). The SQS Scale ranges from 1-5, using whole numbers only. A 5 is a match to the Control; the sample has virtually identical sensory characteristics to the control by appearance, aroma, flavor, and texture. Any differences are insignificant and would not be noticed without careful side-by-side comparison to the control. A 4 is slightly different from the Control; indicating the sample has one or multiple ‘slight’ differences from the control. These differences, however, might not be noticed if not in a side-by-side comparison with the control. A Moderate difference from the Control is a 3; the sample has one of multiple ‘moderate’ differences from the control. These differences would be noticed in one side-by-side comparison with the control. A 2 indicates the sample is extremely different from the Control; the sample has one or multiple ‘extreme’ differences from the control. These differences would be noticed even if not in a side-by-side comparison with the control. A 1 is a reject; the sample has obvious defects that make it different from the Control. This can range from oxidation/degradation notes (e.g. painty or degraded protein) to contaminants (e.g. diacetyl).

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the application is to be interpreted as illustrative and not in a limiting sense.

### EXAMPLES

### Example 1. Strawberry Dairy Drink

The following example relates to a method for making a strawberry dairy drink that contains an amount of SDA enriched soybean oil.

The strawberry dairy drink was made according to the following process. The following table is the list of ingredients and the amount used including percentage by weight of the end product and actual quantities used.

TABLE 1

| Ingredients | % | kg |
|---|---|---|
| Granulated Sugar | 5.000 | 18.927 |
| SDA enriched Soybean oil | 0.779 | 2.949 |
| 2% Milk w/added Vitamins A & D | 92.876 | 351.574 |
| λ (lambda) Carrageenan | 0.020 | 0.076 |
| Red Color | 0.025 | 0.095 |
| Strawberry Flavor | 1.300 | 4.921 |
| Total | 100.000 | 378.541 |

The ingredients were combined and processed according to the following steps to produce the strawberry dairy drink:
A. Carrageenan was combined with sugar in a ratio of 1:10
B. The carrageenan/sugar mixture was blended with the milk (the milk was heated to 27° C. (81° F.) the mixture was blended for 10-15 minutes at a high shear rate;
C. The remaining sugar, red color, and strawberry flavor were added to the slurry and mixed for 10 minutes;
D. The oil was added to the mixture and mixed for 5 minutes;
E. The mixture was next preheated to 70° C. (158° F.);
F. The preheated mixture was Ultra High Temperature (UHT) treated at 142° C. (288° F.) for 4 seconds;
G. The solution was homogenized in two stages at 2500 psi (172 bar) and 500 psi (35 bar) then allowed to cool to below 15° C. (59° F.);
H. Finally, the cooled solution was packaged by filling containers through an aseptic process.

The results were a strawberry dairy drink composition that had an increased amount of n-3 PUFAs, but retained the taste, structure, aroma, and mouthfeel of typical strawberry dairy drink products currently on the market. Thus, the sensory characteristics of the beverage composition containing SDA enriched soybean oil was comparable to the sensory characteristics of the conventional beverage composition. The product delivered 410 mg n-3 PUFAs per 250 mL serving against the target of 375 mg SDA per serving.

### Example 2. Sensory Profiling of Strawberry Dairy Drink Compositions

Sensory descriptive analysis was conducted on strawberry dairy drink compositions over 6 month accelerated shelf life. Testing was conducted at Time 0 and 6 Months (stored at 25° C. and 37° C.) to understand the attribute differences of Soybean Oil and SDA Oil strawberry dairy drink compositions. At Time 0 and at 6 Months seven (7) panelists (all the panelists were trained in the Sensory Spectrum™ Descriptive Profiling method) evaluated the samples for 19 flavor attributes, 8 texture attributes, and 3 aftertaste attributes. The attributes were evaluated on a 15-point scale, with 0=none/not applicable and 15=very strong/high in each sample. Definitions of the flavor attributes are given in Table 2 and definitions of the texture attributes are given in Table 3.

The strawberry dairy drink compositions were shaken, four (4) 250 mL tetra paks were poured into a pitcher, stirred, and then two (2) ounces of the strawberry dairy drink compositions were poured into three (3) ounce Solo® cups with lids (Solo Cup Company, Lake Forest, Ill.). The samples were presented monadically in duplicate.

The data was analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

TABLE 2
Flavor Attribute Lexicon.

| Attribute | Definition | Reference | |
|---|---|---|---|
| | | Intensities based | |
| | | on Universal Scale: | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| AROMATICS | | | |
| Overall Flavor Impact | The overall intensity of the product | | |
| | aromas, an amalgamation of all perceived | | |
| | aromatics, basic tastes and chemical | | |
| | feeling factors. | | |
| Strawberry | The general category used to describe the | Hershey's Strawberry Syrup | |
| | aromatics associated with strawberry | | |
| Sweet Aromatics | The aromatics associated with sweet foods | | |
| Complex | | | |
| Caramelized | The aromatics associated with browned | Caramelized sugar | |
| | sugars such as caramel. | | |
| Vanilla/Vanillin | The aromatics associated with vanilla, | Vanilla Extract, Vanillin | |
| | including artificial vanilla, woody, and | crystals | |
| | browned notes. | | |
| Milky | Aromatic associated with skim milk or | Skim Milk | |
| | milk derived products. | | |
| Dairy Fat | The slightly sweet, buttery (real) aromatic | Heavy cream | |
| | associated with dairy fat. | | |
| Fishy/Pondy Complex | The aroma/aromatics associated with | | |
| | triethylamine, pond water or aged fish. | | |
| | The general term used to describe fish | | |
| | meat, which cannot be tied to a specific | | |
| | fish by name. | | |
| Fishy | Aromatic associated with trimethylamine | Cod liver oil capsules, | |
| | and old fish. | trimethylamine, Geisha | |
| | | canned lump crab, tuna in | |
| | | pouch | |
| Pondy | The aromas and aromatics associated with | Algal oil (Martek 30% DHA | |
| | water containing algae, reminiscent of | oil) | |
| | pond water and aquatic tanks. | | |
| Painty | The aromatic associated with oxidized oil. | Linseed oil | |
| Cardboard/Woody | The aromatics associated with dried wood | Toothpicks, Water from | |
| | and the aromatics associated with slightly | cardboard soaked for 1 hour | |
| | oxidized fats and oils, reminiscent of a | | |
| | cardboard box. | | |
| Overripe/Browned Fruit | The aromatic associated with overripe, | Banana baby food | |
| | browning fruit, slight decomposition. | | |
| BASIC TASTES | | | |
| Sweet | The taste on the tongue stimulated by sucrose | Sucrose solution: | |
| | and other sugars, such as fructose, glucose, etc., | 2% | 2.0 |
| | and by other sweet substances, such as | 5% | 5.0 |
| | saccharin, Aspartame, and Acesulfam-K. | 10% | 10.0 |
| | | 16% | 15.0 |
| Sour | The taste on the tongue stimulated by acid, such | Citric acid solution: | |
| | as citric, malic, phosphoric, etc. | 0.05% | 2.0 |
| | | 0.08% | 5.0 |
| | | 0.15% | 10.0 |
| | | 0.20% | 15.0 |
| Salt | The taste on the tongue associated with sodium | Sodium chloride solution: | |
| | salts. | 0.2% | 2.0 |
| | | 0.35% | 5.0 |
| | | 0.5% | 8.5 |
| | | 0.55% | 10.0 |
| | | 0.7% | 15.0 |
| Bitter | The taste on the tongue associated with caffeine | Caffeine solution: | |
| | and other bitter substances, such as quinine and | 0.05% | 2.0 |
| | hop bitters. | 0.08% | 5.0 |
| | | 0.15% | 10.0 |
| | | 0.20% | 15.0 |
| CHEMICAL FEELING | | | |
| FACTOR | | | |
| Astringent | The shrinking or puckering of the tongue surface | Alum solution: | |
| | caused by substances such as tannins or alum. | 0.005% | 3.0 |
| | | 0.0066% | 5.0 |
| | | 0.01% | 9.0 |

| | | |
|---|---|---|
| Burn | A chemical feeling factor associated with high | Lemon juice, vinegar. |
| | concentration of irritants to the mucous | |
| | membranes of the oral cavity. | |

TABLE 3
Texture Attribute Lexicon

| Attribute | Definition | Reference Scale | |
|---|---|---|---|
| INITIAL | | | |
| Initial Viscosity | The rate of flow per unit force across | Water | 1.0 |
| | tongue. | Plain Silk | 2.0 |
| | Not viscous/Fast - - - Viscous/Slow | Light Cream | 2.2 |
| | | Heavy Cream | 3.5 |
| | | Maple Syrup | 6.8 |
| | | Chocolate Syrup | 9.2 |
| | | Dairy Mixture | 11.7 |
| | | Condensed Milk | 14.0 |
| Amount of Particles | The amount of particles perceived in the | Miracle Whip | 0.0 |
| | sample. | Silk | 0.0 |
| | No particles - - - Many particles | Sour cream + cream of wheat | 5.0 |
| | | Mayo + corn flour | 10.0 |
| Particle Size | The size of the particles perceived in the | Add each to vanilla pudding in a 1:1 ratio. | |
| | sample. (gritty, grainy, lumpy, etc.) | Silk (no mixing w/ pudding) | 0.0 |
| | Very small particles - - - Very large | Vanilla pudding | 0.0 |
| | particles | Corn starch | 1.0 |
| | | My*T*Fine tapioca pudding mix (dry) | 3.5 |
| | | Grape Nuts | 6.5 |
| | | Uncle Ben's white rice (uncooked) | 9.0 |
| | | Tic Tac's | 14.0 |
| TEN | | | |
| MANIPULATIONS | | | |
| Viscosity at 10 | The rate of flow per unit force across | Water | 1.0 |
| Manipulations | tongue. | Light Cream | 2.2 |
| | Not viscous/Fast - - - Viscous/Slow | Plain Silk | 2.5 |
| | | Heavy Cream | 3.5 |
| | | Maple Syrup | 6.8 |
| | | Chocolate Syrup | 9.2 |
| | | Dairy Mixture | 11.7 |
| | | Condensed Milk | 14.0 |
| Mixes with Saliva | The saliva solubility of the product. | JIF Peanut Butter (smooth) | 5.0 |
| | No mixing - - - Complete mixing | Mashed Potatoes | 10.0 |
| | | Jello Chocolate Pudding | 13.5 |
| RESIDUAL | | | |
| Chalky Mouthcoating | The amount of coating/film remaining | Silk (Chalky, Tacky) | 1.0 |
| | in the mouth after expectoration | Cooked corn starch | 3.0 |
| | associated with chalky products such as | Pureed potato | 8.0 |
| | milk of magnesia. | Naked Protein Zone | 14.0 |
| | None - - - A lot | | |
| Slick Mouthcoating | The amount of coating/film remaining | Silk (Chalky, Tacky) | 1.0 |
| | in the mouth after expectoration | Cooked corn starch | 3.0 |
| | associated with slick products such as | Pureed potato | 8.0 |
| | over-ripe fruit. | Naked Protein Zone | 14.0 |
| | None - - - A lot | | |
| Tacky Mouthcoating | The amount of coating/film remaining | Silk (Chalky, Tacky) | 1.0 |
| | in the mouth after expectoration | Cooked corn starch | 3.0 |
| | associated with tacky products such as | Pureed potato | 8.0 |
| | marshmallow fluff. | Naked Protein Zone | 14.0 |
| | None - - - A lot | | |

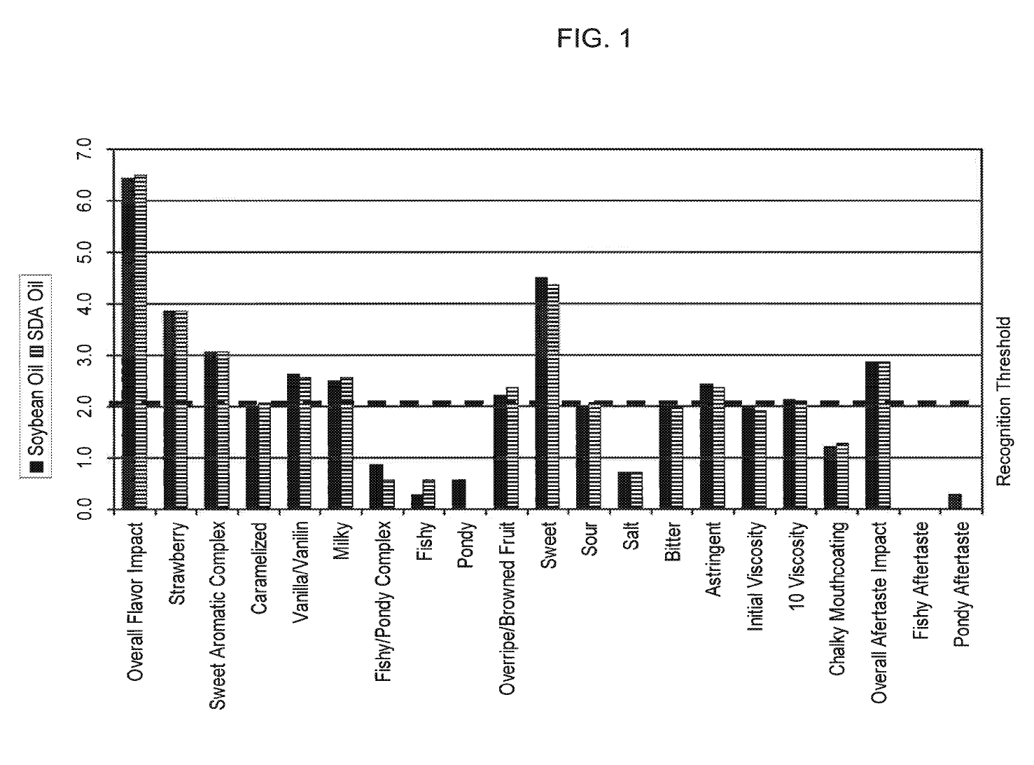

There were detectable differences between the Soybean Oil and SDA Oil strawberry dairy drink compositions at Time 0, shown in Table 4. At Time 0, the Soybean Oil strawberry dairy drink composition was higher in Pondy aromatics, Initial Viscosity, and 10 Viscosity (FIG. 1).

At Time 0, the Fishy/Pondy aromatics in both the Soybean Oil and SDA Oil strawberry dairy drink compositions were below the recognition threshold (2.0); therefore consumers would not be able to detect these aromatics in the samples.

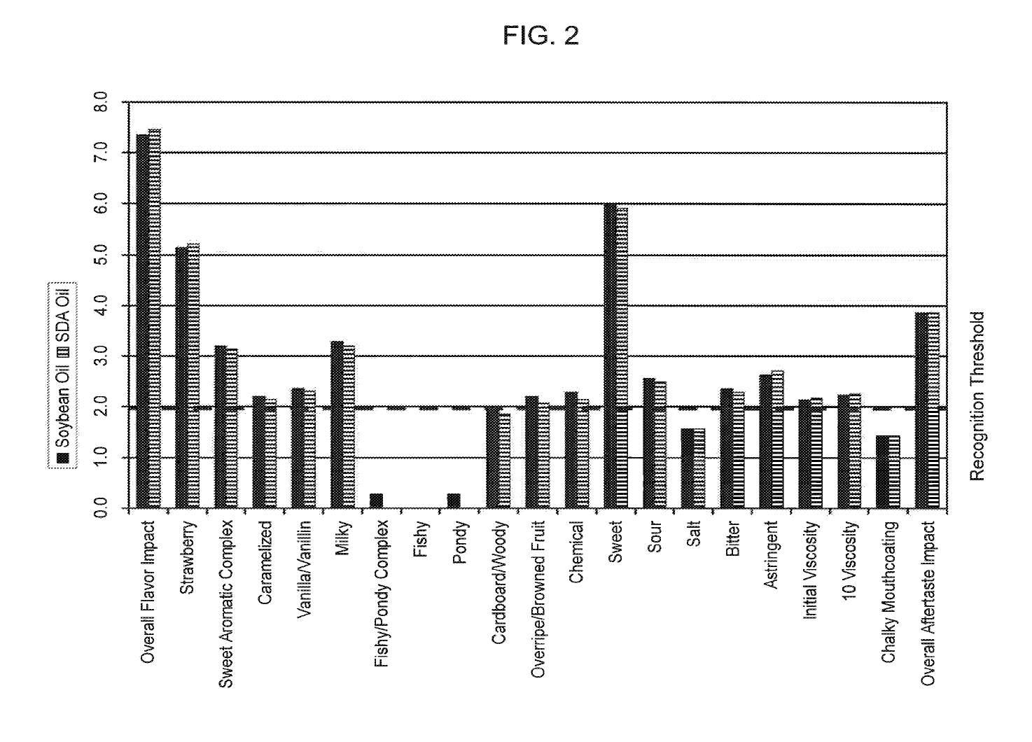

There were detectable differences between Soybean Oil and SDA Oil at 6 Months stored at 25° C., shown in Table 5. At 6 Months stored at 25° C., the Soybean Oil strawberry dairy drink composition was higher in Cardboard/Woody aromatics, Overripe/Browned Fruit aromatics, and Chemical aromatics (FIG. 2). This sample also had Fishy/Pondy aromatics, but below the recognition threshold (2.0).

At 6 Months stored at 25° C., the SDA Oil sample was higher in Overall Flavor Impact, Initial Viscosity, and 10 Viscosity (FIG. 2). This sample also did not have any Fishy/Pondy aromatics.

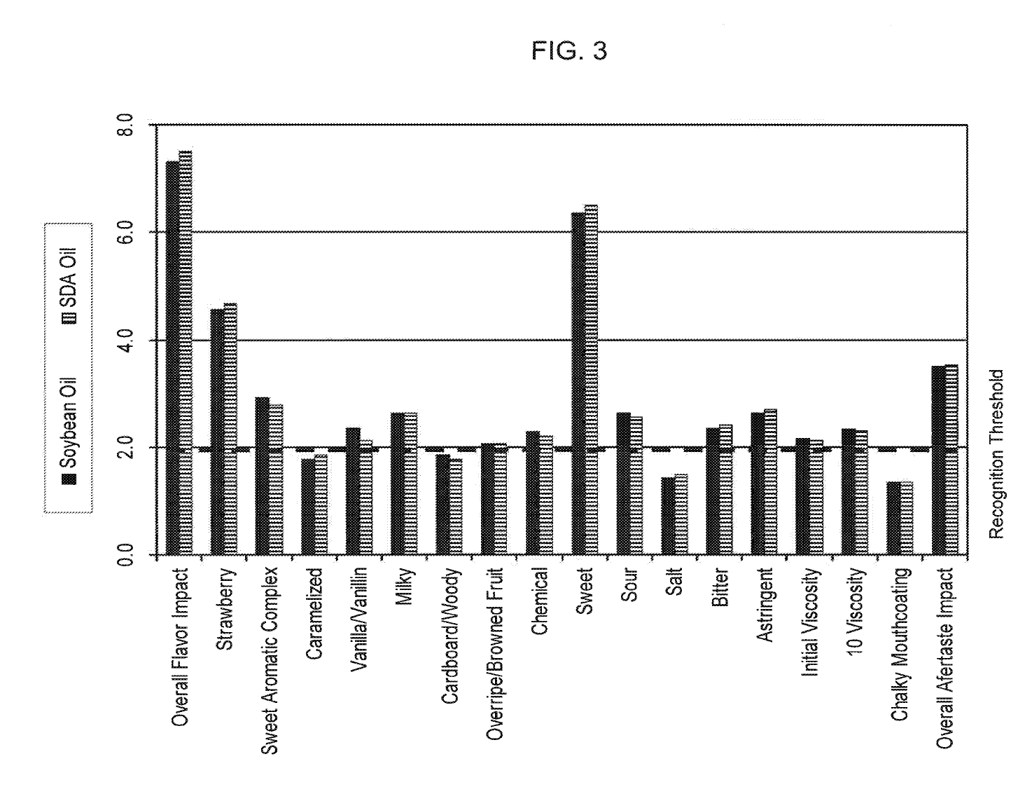

There were detectable differences between the Soybean Oil and SDA Oil strawberry dairy drinks at 6 Months stored at 37° C., shown in Table 6. At 6 Months stored at 37° C., the Soybean Oil strawberry dairy drink composition was higher in Vanilla/Vanillin aromatics (FIG. 3). This sample also had Ashy aromatics, but no Fishy/Pondy aromatics.

At 6 Months stored at 37° C., the SDA Oil strawberry dairy drink composition was higher in Sweet basic taste (FIG. 3). This sample also did not have any Fishy/Pondy aromatics. In addition, at the end of 6 months shelf life at both 25° C. and 37° C., there were no off notes, such as Painty aromatics, which would indicate oxidation.

TABLE 4
Mean Scores for Flavor, Texture, and Aftertaste Attributes at Time 0

| | Soybean Oil | SDA Oil | p value |
|---|---|---|---|
| Aromatics | | | |
| Overall Flavor Impact | 6.4 a | 6.5 a | NS |
| Strawberry | 3.9 a | 3.9 a | NS |
| Sweet Aromatic | 3.1 a | 3.1 a | NS |
| Complex | | | |
| Caramelized | 2.0 a | 2.1 a | * |
| Vanilla/Vanilin | 2.6 a | 2.6 a | * |
| Milky | 2.5 a | 2.6 a | NS |
| Dairy Fat | 0.0 a | 0.0 a | n/a |
| Fishy/Pondy Complex | 0.9 a | 0.6 a | NS |
| Fishy | 0.3 a | 0.6 a | * |
| Pondy | 0.6 a | 0.0 b | *** |
| Painty | 0.0 a | 0.0 a | n/a |
| Cardboard/Woody | 0.6 a | 0.6 a | NS |
| Overripe/Browned | 2.2 a | 2.4 a | * |
| Fruit | | | |
| Basic Tastes & | | | |
| Feeling Factors | | | |
| Sweet | 4.5 a | 4.4 a | NS |
| Sour | 2.0 a | 2.1 a | * |
| Salt | 0.7 a | 0.7 a | NS |
| Bitter | 2.0 a | 2.0 a | NS |
| Astringent | 2.4 a | 2.4 a | * |
| Burn | 0.0 a | 0.0 a | n/a |
| Texture & Mouthfeel | | | |
| Initial Viscosity | 1.96 a | 1.91 b | ** |
| Particle Amount | 0.0 a | 0.0 a | n/a |
| Particle Size | 0.0 a | 0.0 a | n/a |
| 10 Viscosity | 2.14 a | 2.10 b | ** |
| Mixes with Saliva | 14.0 a | 14.0 a | NS |
| Chalky Mouthcoating | 1.2 a | 1.3 a | * |
| Slick Mouthcoating | 0.0 a | 0.0 a | n/a |
| Tacky Mouthcoating | 0.0 a | 0.0 a | n/a |
| Aftertaste | | | |
| Overall Afertaste | | | |
| Impact | 2.9 a | 2.9 a | NS |
| Fishy Aftertaste | 0.0 a | 0.0 a | NS |
| Pondy Aftertaste | 0.3 ab | 0.0 b | * |

Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

TABLE 5
Mean Scores for Flavor, Texture, and Aftertaste Attributes at 6 Months
stored at 25° C.

| | Soybean Oil | SDA Oil | p value |
|---|---|---|---|
| Aromatics | | | |
| Overall Flavor Impact | 7.4 b | 7.5 a | ** |
| Strawberry | 5.1 a | 5.2 a | * |
| Sweet Aromatic Complex | 3.2 a | 3.1 a | * |
| Caramelized | 2.2 a | 2.1 a | * |
| Vanilla/Vanillin | 2.4 a | 2.3 a | NS |
| Milky | 3.3 a | 3.2 a | * |
| Dairy Fat | 0.0 a | 0.0 a | n/a |
| Fishy/Pondy Complex | 0.3 a | 0.0 a | * |
| Fishy | 0.0 a | 0.0 a | n/a |
| Pondy | 0.3 a | 0.0 a | * |
| Painty | 0.0 a | 0.0 a | n/a |
| Cardboard/Woody | 2.0 a | 1.9 b | *** |
| Overripe/Browned Fruit | 2.2 a | 2.1 b | ** |
| Chemical | 2.3 a | 2.1 b | ** |
| Basic Tastes & Feeling Factors | | | |
| Sweet | 6.0 a | 5.9 a | NS |
| Sour | 2.6 a | 2.5 a | * |
| Salt | 1.6 a | 1.6 a | NS |
| Bitter | 2.4 a | 2.3 a | NS |
| Astringent | 2.6 a | 2.7 a | * |
| Burn | 0.5 a | 0.6 a | NS |
| Texture & Mouthfeel | | | |
| Initial Viscosity | 2.14 b | 2.17 a | *** |
| Particle Amount | 0.0 a | 0.0 a | n/a |
| Particle Size | 0.0 a | 0.0 a | n/a |
| 10 Viscosity | 2.24 b | 2.27 a | *** |
| Mixes with Saliva | 14.0 a | 14.0 a | NS |
| Chalky Mouthcoating | 1.4 a | 1.4 a | NS |
| Slick Mouthcoating | 0.0 a | 0.0 a | n/a |
| Tacky Mouthcoating | 0.0 a | 0.0 a | n/a |
| Aftertaste | | | |
| Overall Aftertaste Impact | 3.9 a | 3.9 a | NS |
| Fishy Aftertaste | 0.0 a | 0.0 a | n/a |
| Pondy Aftertaste | 0.0 a | 0.0 a | n/a |

Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

TABLE 6
Mean Scores for Flavor, Texture, and Aftertaste Attributes at
6 Months stored at 37° C.

| | Soybean Oil | SDA Oil | p value |
|---|---|---|---|
| Aromatics | | | |
| Overall Flavor Impact | 7.3 a | 7.5 a | * |
| Strawberry | 4.6 a | 4.7 a | NS |
| Sweet Aromatic Complex | 2.9 a | 2.8 a | * |
| Caramelized | 1.8 a | 1.9 a | * |
| Vanilla/Vanillin | 2.4 a | 2.1 b | *** |
| Milky | 2.6 a | 2.6 a | NS |
| Dairy Fat | 0.0 | 0.0 | n/a |
| Fishy/Pondy Complex | 0.0 | 0.0 | n/a |
| Fishy | 0.0 | 0.0 | n/a |
| Pondy | 0.0 | 0.0 | n/a |
| Painty | 0.0 | 0.0 | n/a |
| Cardboard/Woody | 1.9 a | 1.8 a | NS |
| Overripe/Browned Fruit | 2.1 a | 2.1 a | NS |
| Chemical | 2.3 a | 2.2 a | * |
| Other Aromatic: Ashy | 2.0 (14%) | 0.0 | |
| Basic Tastes & Feeling Factors | | | |
| Sweet | 6.4 b | 6.5 a | *** |
| Sour | 2.6 a | 2.6 a | * |
| Salt | 1.4 a | 1.5 a | * |
| Bitter | 2.4 a | 2.4 a | * |
| Astringent | 2.6 a | 2.7 a | * |
| Burn | 0.6 a | 0.4 a | NS |
| Texture & Mouthfeel | | | |
| Initial Viscosity | 2.16 a | 2.13 a | * |
| Particle Amount | 0.0 | 0.0 | n/a |
| Particle Size | 0.0 | 0.0 | n/a |
| 10 Viscosity | 2.34 a | 2.31 a | * |
| Mixes with Saliva | 13.9 a | 13.9 a | NS |
| Chalky Mouthcoating | 1.4 a | 1.4 a | NS |
| Slick Mouthcoating | 0.1 a | 0.1 a | NS |
| Tacky Mouthcoating | 0.0 | 0.0 | n/a |
| Aftertaste | | | |
| Overall Afertaste | 3.5 a | 3.5 a | NS |
| Fishy Aftertaste | 0.0 | 0.0 | n/a |
| Pondy Aftertaste | 0.0 | 0.0 | n/a |

Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

### Example 3. Acceptance of Strawberry Dairy Drink Compositions

To evaluate sensory parity of Soybean Oil and SDA Oil consumer acceptability based on Soybean Oil and SDA Oil strawberry dairy drink compositions were analyzed. The acceptance ratings were compared between the Soybean Oil and SDA Oil strawberry dairy drink compositions over the 6 Month accelerated shelf life. Acceptance was conducted at 4 Months and 6 Months at 25° C.

The samples at 4 Months were evaluated by 40 consumers willing to try strawberry dairy drink compositions. The samples at 6 Months were evaluated by 57 consumers willing to try strawberry dairy drink compositions. The judges used a 9-point Hedonic acceptance scale. The Hedonic scale ranged from 1 being dislike extremely to 9 being like extremely and was used for Overall Liking, Color Liking, Flavor Liking, Mouthfeel Liking, Texture Liking, and Aftertaste Liking.

Consumers evaluated two (2) ounces of each sample that were poured into three (3) ounce cups with lid. Samples were refrigerated until served. The samples were served by sequential monadic presentation (one at a time).

The data was analyzed using the Analysis of Variance (ANOVA) to account for panelist and sample effects, with mean separations using Tukey's Significant Difference (HSD) Test.

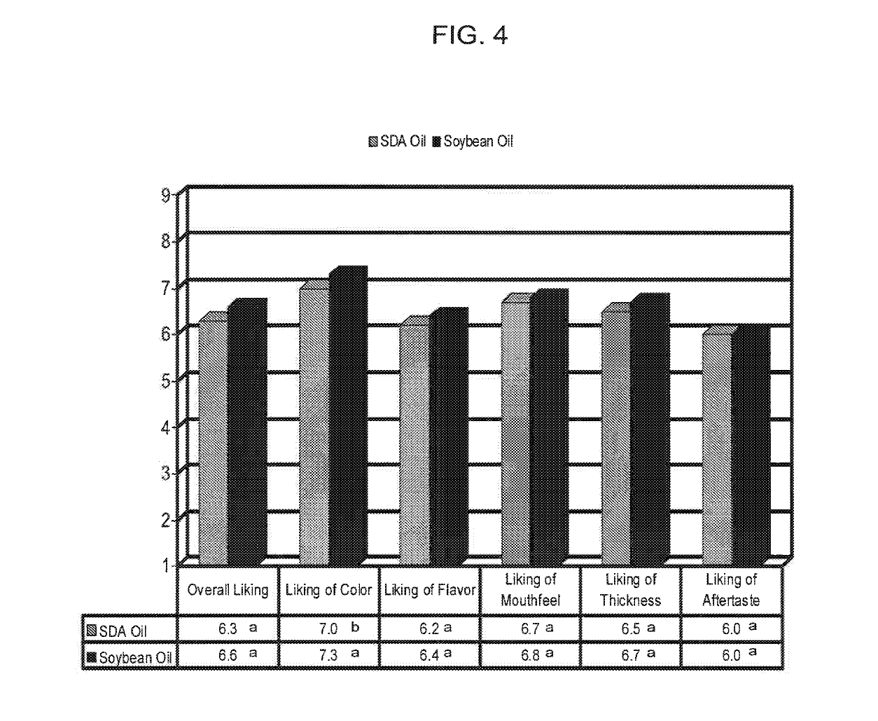

At 4 Months of being stored at 25° C., there were no significant differences between Soybean Oil and SDA Oil strawberry dairy drink compositions in Overall Liking, Flavor Liking, Mouthfeel Liking, Thickness Liking, and Aftertaste Liking (FIG. 4).

At 4 Months of being stored at 25° C., mean scores of Soybean Oil were significantly higher compared to SDA Oil in Color Liking (FIG. 4). However, this difference did not affect the Overall Liking of the SDA Oil strawberry dairy drink composition.

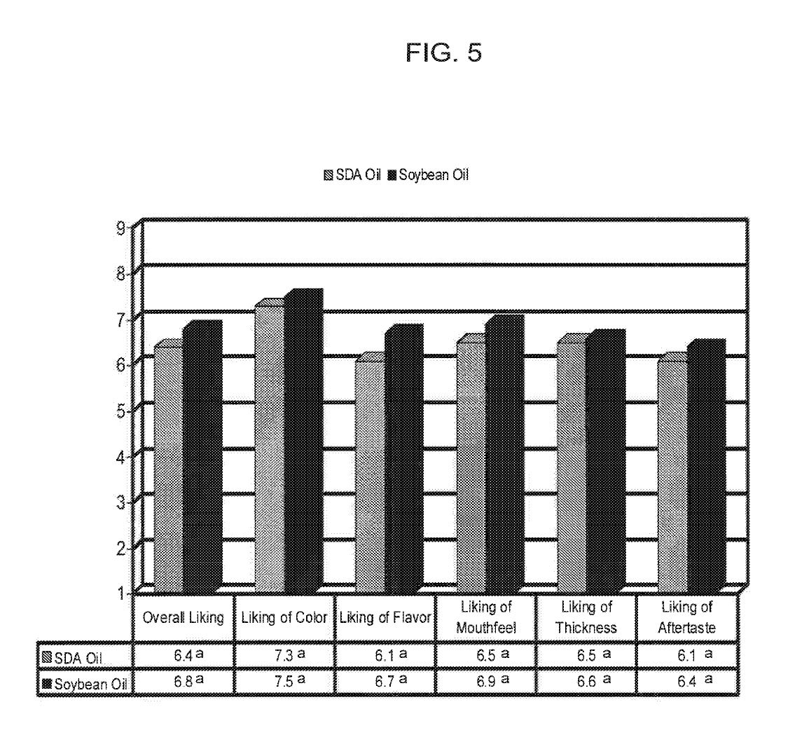

At 6 Months of being stored at 25° C., there were no significant differences between Soybean Oil and SDA Oil strawberry dairy drink compositions in Overall Liking, Color Liking, Flavor Liking, Mouthfeel Liking, Thickness Liking, and Aftertaste Liking (FIG. 5).

### Example 4. Vanilla Soymilk

The following example relates to a method for making a vanilla soymilk that contains an amount of SDA enriched soybean oil.

The vanilla soymilk was made according to the following process. Table 7 shows the list of ingredients and the amounts used including the percentages by weight of the end product and actual quantities used.

TABLE 7

| | | Control | | |
|---|---|---|---|---|
| | | soybean oil | | SDA-enriched |
| Ingredients | % | (g) | % | soybean oil (g) |
| SUPRO ® Plus 651 | 3.10 | 372.00 | 3.10 | 372.00 |
| Granulated sugar | 3.50 | 420.00 | 3.50 | 420.00 |
| Maltodextrin | 4.00 | 480.00 | 4.00 | 480.00 |
| Soybean oil | 1.83 | 219.60 | 1.13 | 135.60 |
| SDA enriched | 0.00 | 0.00 | 0.70 | 84.00 |
| soybean oil | | | | |
| I (Iota) Carrageenan | 0.01 | 1.20 | 0.01 | 1.20 |
| Potassium Citrate | 0.20 | 24.00 | 0.20 | 24.00 |
| Monohydrate | | | | |
| Cellulose gel | 0.25 | 30.00 | 0.25 | 30.00 |
| Salt | 0.03 | 3.60 | 0.03 | 3.60 |
| Water | 86.81 | 10417.20 | 86.81 | 10417.20 |
| Dipotassium | 0.05 | 6.00 | 0.05 | 6.00 |
| Phosphate | | | | |
| Lecithin | 0.15 | 18.00 | 0.15 | 18.00 |
| Vanilla flavor 1 | 0.02 | 2.40 | 0.02 | 2.40 |
| Vanilla flavor 2 | 0.05 | 6.00 | 0.05 | 6.00 |
| Total | 100.00 | 12000.00 | 100.00 | 12000.00 |

The ingredients were combined and processed according to the following steps to produce the soymilk:
A. The water was added to a Groen Jacked Steam kettle, mixing vessel, with agitation and heating to 60° C. (140° F.);
B. Potassium Citrate Monohydrate was dispersed into the water and mixed for 1 minute;
C. The SUPRO® Plus was added to the water and dispersed at moderate to high speed for 10 minutes while increasing temperature to 77° C. (170° F.);
D. The carrageenan, granulated sugar, maltodextrin, and salt were added to the protein slurry with continuous mixing for 5 minutes at low speed;
E. The oil was then added to the slurry and slowly mixed until homogenous, about 3 minutes;
F. The Vanilla flavorings were added with continuous agitation;
G. The pH was checked to ensure it was in the range of 7.0-7.2;
H. The mixture was then heated to 72° C. (162° F.) and homogenized in two stages at 2500 (172 bar) and 500 psi (35 bar);
I. The mixture was then preheated to 104° C. (220° F.) and UHT processed at 141° C. (286° F.) for 6 seconds;
J. The product was then cooled and filled aseptically into sterilized containers;
K. The filled containers were then placed in a chilled water bath to cool to about 10° C. (50° F.);
L. After cooling the containers were labeled and refrigerated.

The results were a soymilk composition that has an increased quantity of n-3 PUFAs, but retains the taste, structure, aroma, and mouthfeel of typical soymilk products currently on the market. The product delivers a substantial amount of n-3 PUFAs in the form of 375 mg SDA per 250 mL serving against the target of 375 mg SDA per serving.

### Example 5. Sensory SQS of Plain Soymilk

Solae Qualitative Screening (SQS) was conducted on plain soymilk to understand the attribute differences of Soybean Oil and SDA Oil in plain soymilk. Nine panelists trained in the SQS method on plain soymilk evaluated the samples for 13 flavor attributes. Definitions of the flavor attributes are given in Table 8. They used the SQS Scale to measure the degree of difference from the Control (Soybean Oil) sample.

Two (2) ounces of the sample were poured into three (3) ounce cups with lids. Panelists followed the procedure of tasting the Control (Soybean Oil) sample first, using standard tasting methodology then tasting the test sample (SDA Oil) and evaluated the differences from the Control (Soybean Oil) sample. The Plain Soymilk SQS Ballot is given in Table 9.

The data from all nine panelists were averaged to determine if any differences between the Soybean Oil and SDA Oil plain soymilk existed.

TABLE 8
Flavor Attribute Lexicon.

| | | |
|---|---|---|
| Attribute | Definition | Reference |

AROMATICS

| | | |
|---|---|---|
| Overall Flavor Impact | The overall intensity of the product aromas, an | |
| | amalgamation of all perceived aromatics, basic | |
| | tastes and chemical feeling factors. | |
| Green | The general category of aromatics associated with | Green beans |
| | green vegetation including stems, grass, leaves and | |
| | green herbs. | |
| Vanilla | The aromatics associated with vanilla, including | Vanilla Extract |
| | artificial vanilla, woody, and browned notes. | |
| Grain | The aromatics associated with the total grain | All-purpose flour paste |
| | impact, which may include all types of grain and | |
| | different stages of heating. May include wheat, | |
| | whole wheat, oat, rice, graham, etc | |
| Soy/Legume | The earthy/dirty, green aromatics associated with | Unsweetened Silk, Canned |
| | legumes/soybeans; may include all types and | Soybeans |
| | different stages of heating. | |
| Cardboard/Woody | The aromatics associated with dried wood and the | Water from cardboard soaked |
| | aromatics associated with slightly oxidized fats and | for 1 hour |
| | oils, reminiscent of a cardboard box. | |
| Fishy/Pondy Complex | The aroma/aromatics associated with triethylamine, | |
| | pond water or aged fish. The general term used to | |
| | describe fish meat, which cannot be tied to a | |
| | specific fish by name. | |
| Fishy | Aromatic associated with trimethylamine and old | Cod liver oil capsules |
| | fish. | |
| Pondy | The aromas and aromatics associated with water | Algal oil (Martek 30% DHA |
| | containing algae, reminiscent of pond water and | oil) |
| | aquatic tanks. | |

BASIC TASTES

| | | |
|---|---|---|
| Sweet | The taste on the tongue stimulated by sucrose and | Sucrose solutions |
| | other sugars, such as fructose, glucose, etc., and by | |
| | other sweet substances, such as saccharin, | |
| | Aspartame, and Acesulfam-K. | |
| Sour | The taste on the tongue stimulated by acid, such as | Citric acid solution |
| | citric, malic, phosphoric, etc. | |
| Salt | The taste on the tongue associated with sodium | Sodium chloride solution |
| | salts. | |
| Bitter | The taste on the tongue associated with caffeine and | Caffeine solution |
| | other bitter substances, such as quinine and hop | |
| | bitters. | |

CHEMICAL FEELING FACTOR

| | | |
|---|---|---|
| Astringent | The shrinking or puckering of the tongue surface | Alum solution |
| | caused by substances such as tannins or alum. | |

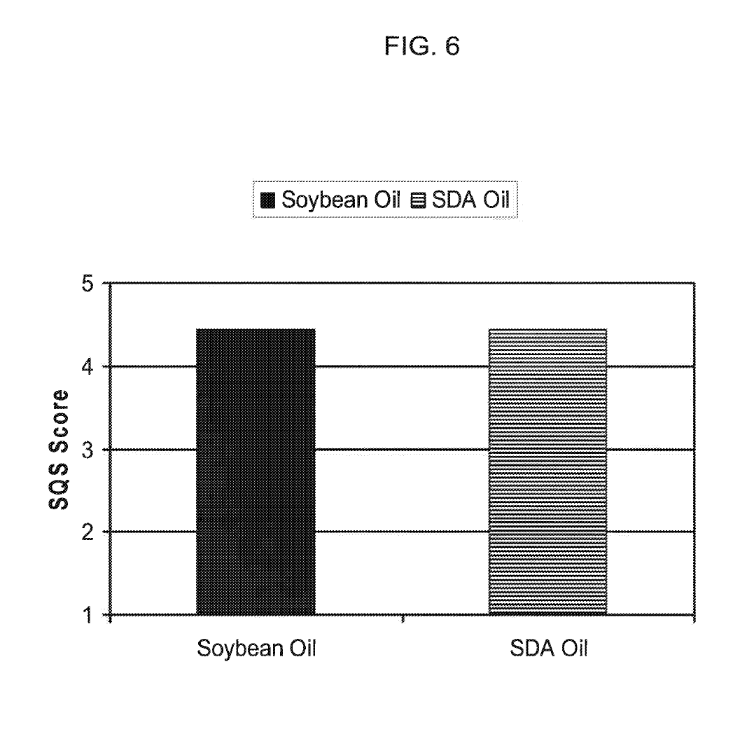

The SDA Oil plain soymilk was within normal product variation (FIG. 6), the Soybean Oil plain soymilk had the same SQS score as the SDA Oil plain soymilk, shown in Table 10.

TABLE 10
SQS Scores for Plain Soymilk

| | SQS Score |
|---|---|
| Soybean Oil | 4.44 |
| SDA Oil | 4.44 |

### Example 6. Mixed Berry Smoothie

The following example relates to a method for making a mixed berry smoothie that contains an amount of SDA enriched soybean oil.

The mixed berry smoothie was made according to the following process. Table 11 is the list of ingredients and the quantities used including percentage by weight of the end product and actual quantities used.

TABLE 11

| | | Control | | |
|---|---|---|---|---|
| | | soybean | | SDA-enriched |
| | | Oil | | soybean oil |
| | | formulation | | formulation |
| Ingredients | % | (g) | % | (g) |
| Water for stabilizer | 40.95 | 5733.00 | 40.95 | 5733.00 |
| portion | | | | |
| Water for soymilk | 40.95 | 5733.00 | 40.95 | 5733.00 |
| portion | | | | |
| Pectin | 0.70 | 98.00 | 0.70 | 98.00 |
| Sugar | 8.70 | 1218.00 | 0.70 | 98.00 |
| Citric acid, anhydrous | 0.31 | 43.40 | 8.70 | 1218.00 |
| Soybean oil | 0.71 | 98.98 | 0.00 | 0.00 |
| 20% SDA enriched | | 0.000 | 0.71 | 98.98 |
| soybean oil | | | | |
| SUPRO ® XT 219D | 2.70 | 378.00 | 2.70 | 378.00 |
| Isolated Soy Protein | | | | |
| Potassium citrate, | 0.06 | 8.40 | 0.06 | 8.40 |
| granular | | | | |
| Lecithin | 0.08 | 11.20 | 0.08 | 11.20 |
| Salt | 0.06 | 8.40 | 0.06 | 8.40 |
| Peach juice | 4.00 | 560.00 | 4.00 | 560.00 |
| concentrate 65° Brix | | | | |
| Marion seedless | 0.50 | 70.00 | 0.50 | 70.00 |
| blackberry puree | | | | |
| Blueberry puree | 0.12 | 17.26 | 0.12 | 17.26 |
| Blueberry type flavor | 0.05 | 7.00 | 0.05 | 7.00 |
| Color Magenta | 0.11 | 15.75 | 2.70 | 378.00 |
| Total | 100.00 | 14000.00 | 100.00 | 14000.00 |

The ingredients were combined and processed according to the following steps to produce the mixed berry smoothie:
A. First the stabilizer portion was made by adding the portion of water for the stabilizing portion into a mixing vessel and the water was agitated;
B. The water was heated to 44° C. (111° F.);
C. Pectin was mixed with a portion of the sugar and the mixture was slowly added to the water, with a Groen Jacked Steam kettle set at a high mixing speed for 5 minutes to allow hydration;
D. The citric acid was then added to the mixture;
E. The soymilk portion was made by adding the portion of water for the soymilk to a Hobart mixer, mixing vessel, and agitating the water;
F. The water was then heated to 44° C. (111° F.);
G. The SUPRO®XT 219D, was added to the water and agitated until well dispersed;
H. Potassium citrate, lecithin, salt, and oil were then added to the mixture and agitated;
I. The soymilk portion and stabilizer portion were then combined in a larger steam jacketed mixing vessel
J. The fruit purees, color, and flavoring were then added to the mixture and mixed until uniform, A pH measurement was then taken to ensure the pH range was 4.2±0.2;
K. The mixture was then heated to 70° C. (160° F.) and homogenized in two stages at 2500 psi (172 bar) and 500 psi (35 bar);
L. The mixture was heat processed at 107° C. (224° F.) for 19 seconds;
M. The mixture was then cooled and filled in sterilized containers;
N. The filled containers were then placed in a chilled water bath to cool to about 10° C. (50° F.);
O. After cooling the containers were labeled and refrigerated.

The results were a mixed berry smoothie composition that has an increased amount of n-3 PUFAs but retains the taste, structure, aroma, and mouthfeel of typical mixed berry smoothie products currently on the market. The product delivers a substantial amount of n-3 PUFAs, in the form of 375 mg SDA per 250 mL serving against the target of 375 mg SDA per serving.

### Example 7. Sensory SQS of Mixed Berry Smoothie

SQS was conducted on the mixed berry smoothie to understand the attribute differences of Soybean Oil and SDA Oil in the mixed berry smoothie. Six (6) panelists trained in the SQS method on the mixed berry smoothie evaluated the samples for thirteen (13) flavor attributes. Definitions of the flavor attributes are given in Table 12. They used the SQS Scale to measure the degree of difference from the Control (Soybean Oil) sample.

Two (2) ounces of the samples were poured into three (3) ounce cups with lids. Panelists followed the procedure of tasting the control (Soybean Oil) sample first, using standard tasting methodology, then tasting the test sample (SDA Oil) and evaluated the differences from the control sample. The Mixed Berry Smoothie SQS Ballot is given in Table 13.

The data from all six (6) panelists were averaged to determine if any differences between the Soybean Oil and SDA Oil mixed berry smoothie existed.

TABLE 12
Flavor Attribute Lexicon

| Attribute | Definition | Reference |
|---|---|---|
| AROMATICS | | |
| Overall Flavor | The overall intensity of the product aromas, an | |
| Impact | amalgamation of all perceived aromatics, basic | |
| | tastes and chemical feeling factors. | |
| Mixed Berry | The aromatic associated with cooked berries | Smucker's 100% Fruit |
| | (peach, blueberries, blackberries) | Blueberry, Polaner All Fruit |
| | | Blackberry, Peach-o's |
| Soy/Legume | The earthy/dirty, green aromatics associated | Unsweetened Silk |
| | with legumes/soybeans; may include all types | |
| | and different stages of heating. | |
| Fishy/Pondy | The aroma/aromatics associated with | |
| Complex | triethylamine, pond water or aged fish. The | |
| | general term used to describe fish meat, which | |
| | cannot be tied to a specific fish by name. | |
| Fishy | Aromatic associated with trimethylamine and | Cod liver oil capsules, |
| | old fish. | trimethylamine, Geisha canned |
| | | lump crab |
| Pondy | The aromas and aromatics associated with | Algal oil (Martek 30% DHA |
| | water containing algae, reminiscent of pond | oil) |
| | water and aquatic tanks. | |
| Painty | The aromatic associated with oxidized oil. | Linseed oil |
| Cardboard/Woody | The aromatics associated with dried wood and | Toothpicks, Water from |
| | the aromatics associated with slightly oxidized | cardboard soaked for 1 hour |
| | fats and oils, reminiscent of a cardboard box. | |
| Basic Tastes | | |
| Sweet | The taste on the tongue stimulated by sucrose | Sucrose solution |
| | and other sugars, such as fructose, glucose, etc., | |
| | and by other sweet substances, such as | |
| | saccharin, Aspartame, and Acesulfame-K. | |
| Sour | The taste on the tongue stimulated by acid, such | Citric acid solution |
| | as citric, malic, phosphoric, etc. | |
| Salt | The taste on the tongue associated with sodium | Sodium chloride solution: |
| | salts. | |
| Bitter | The taste on the tongue associated with caffeine | Caffeine solution |
| | and other bitter substances, such as quinine and | |
| | hop bitters. | |
| Chemical Feeling | | |
| Factor | | |
| Astringent | The shrinking or puckering of the tongue | Alum solution |
| | surface caused by substances such as tannins or | |
| | alum. | |

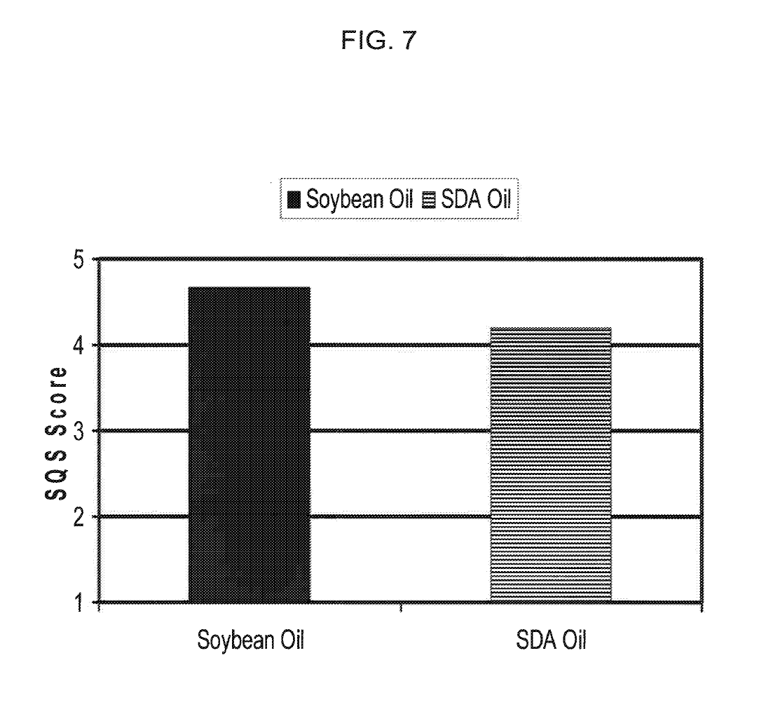

The SDA Oil mixed berry smoothie was slightly different from the Soybean Oil mixed berry smoothie, which was the control sample (FIG. 7) as shown by the SQS Scores in Table 14.

TABLE 14
SQS Scores for Mixed Berry Smoothie

| | SQS Score |
|---|---|
| Soybean Oil | 4.67 |
| SDA Oil | 4.20 |

### Example 8 Clinical Nutrition Beverage

The following example relates to a method for making a clinical nutrition beverage that contains an amount of SDA enriched soybean oil.

The clinical nutrition beverage was made according to the following process. Table 15 shows the list of ingredients and the quantities used including percentage by weight of the end product and actual quantities used.

TABLE 15

| | Control | | SDA-enriched | |
|---|---|---|---|---|
| | soybean oil | | soybean Oil | |
| Ingredient | % | (g) | % | (g) |
| Distilled Water | 78.71 | 19676.75 | 78.71 | 19676.75 |
| Sodium Caseinate | 1.35 | 337.50 | 1.35 | 337.50 |
| Calcium Caseinate | 1.35 | 337.50 | 1.35 | 337.50 |
| SUPRO ® 1611, | 2.70 | 675.00 | 2.70 | 675.00 |
| Isolated Soy Protein | | | | |
| Sucrose | 7.00 | 1750.00 | 7.00 | 1750.00 |
| Corn syrup solids (25DE) | 4.50 | 1125.00 | 4.50 | 1125.00 |
| Soybean oil | 0.80 | 200.00 | 0.00 | 0.00 |
| SDA Oil | 0.00 | 0.00 | 0.80 | 200.00 |
| Canola oil | 0.75 | 187.50 | 0.75 | 187.50 |
| Corn oil | 0.70 | 175.00 | 0.70 | 175.00 |
| Lecithin | 0.12 | 30.75 | 0.12 | 30.75 |
| Tricalcium phosphate | 0.20 | 50.00 | 0.20 | 50.00 |
| Magnesium phosphate | 0.21 | 52.50 | 0.21 | 52.50 |
| Sodium citrate | 0.190 | 47.50 | 0.19 | 47.50 |
| Potassium citrate | 0.59 | 147.50 | 0.59 | 147.50 |
| Sodium chloride | 0.100 | 25.00 | 0.100 | 25.00 |
| λ(lambda) Carrageenan | 0.01 | 1.25 | 0.005 | 1.25 |
| Cellulose gel | 0.50 | 125.00 | 0.50 | 125.00 |
| Vitamin Premix | 0.07 | 16.25 | 0.07 | 16.25 |
| Vanilla flavor | 0.16 | 40.00 | 0.16 | 40.00 |
| Total | 100.00 | 25000.00 | 100.00 | 25000.00 |

The ingredients were processed according to the following steps to produce the clinical nutrition beverage:
A. The distilled water was added to a 19 gallon tank. Sodium and potassium citrates were added to the distilled water with agitation and the mixture was heated to 60° C. (140° F.);
B. The SUPRO®1611 was added to the mixture and heated to 65° to 70° C. (149° F. to 158° F.) and hydrated for 15 minutes, forming a protein slurry;
C. The protein slurry was homogenized in two stages at 2500 psi (172 bar) and 500 psi (35 bar) and returned to the tank;.
D. A portion of the sugar, cellulose gel, and carrageenan were dry mixed together and then added to the homogenized protein slurry and mixed for 10 minutes;
E. The protein slurry was heated to 60° C. (140° F.) and then a mixture consisting of the caseinates together with the remaining sugar was added and the resulting protein slurry was hydrated for 10 minutes;
F. The remaining carbohydrates and minerals were added to the protein slurry and mixed for 5 minutes;
G. The oil and lecithin were mixed together separately from the protein slurry, heated to 60° C. (140° F.) and then added to the protein slurry and mixed for 5 minutes;
H. The vitamin premix and with the flavor were added to the protein slurry and mixed for 2 minutes;
I. The beverage was then homogenized in two stages at 3000 psi (207 bar) and 500 psi (35 bar) and passed through a UHT process at 144° C. (292° F.) for 5 seconds;
J. The beverage was collected in cans at 21° C.-32° C. (70° F.-90° F.) leaving a ½″ headspace in the can. The product was then sterilized by retorting at 121° C. (250° F.) for 7 minutes.

The results were a clinical nutrition beverage composition that has an increased amount of n-3 PUFAs, but retains the taste, structure, aroma, and mouthfeel of typical clinical nutrition beverage products currently on the market. The product delivers a substantial amount of n-3 PUAs, 472 mg SDA per 253 g serving against the target of 375 mg SDA per serving.

### Example 9. Profiling of Clinical Nutrition Beverage

Sensory descriptive analysis was conducted on the clinical nutrition beverage during the shelf life. Testing was conducted at Time 0 and 4 Months (stored at 25° C.) to understand the attribute differences of Soybean Oil and SDA Oil in the clinical nutrition beverage. At Time 0 there were eight (8) panelists and at 4 Months there were six (6) panelists; all the panelists were trained in the Sensory Spectrum™ Descriptive Profiling method. The panelists evaluated the samples for 19 flavor attributes, 8 texture attributes, and 3 aftertaste attributes. The attributes were evaluated on a 15-point scale, with 0=none/not applicable and 15=very strong/high in each sample. Definitions of the flavor attributes are given in Table 16 and definitions of the texture attributes are given in Table 3.

The clinical nutrition beverages were shaken and then two (2) ounces of the sample were poured into three (3) ounce cups with lids. The samples were presented monadically in duplicate.

The data was analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute

TABLE 16
Flavor Attribute Lexicon.

| Attribute | Definition | Reference | |
|---|---|---|---|
| | | Intensities based on | |
| | | Universal Scale: | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| AROMATICS | | | |
| Overall Flavor Impact | The overall intensity of the product aromas, an | | |
| | amalgamation of all perceived aromatics, basic tastes | | |
| | and chemical feeling factors. | | |
| Sweet Aromatics | The general category of aromatics associated with | | |
| Complex | sweet foods. | | |
| caramelized | The aromatics associated with browned sugars such as | Caramelized sugar | |
| | caramel. | | |
| vanilla/vanillin | The aromatics associated with vanilla, including | Vanilla Extract, Vanillin | |
| | artificial vanilla, woody, and browned notes. | crystals | |
| lactone | The sweet, tropical, nutty aromatic associated with | Cocoa butter, imitation | |
| | meat or milk from coconut. | coconut flavor | |
| Milky | The slightly sour, animal, milky aromatic associated | Skim Milk | |
| | with skim milk and milk derived products. | | |
| Dairy Fat | The slightly sweet, buttery (real) aromatic associated | Heavy cream | |
| | with dairy fat. | | |
| Barnyard | Aromatic characteristic of a barnyard; combination of | Old casein, white pepper, | |
| | manure, urine, moldy hay, feed, livestock odors | processed rotten potatoes | |
| Animal | Aroma similar to smell of live animal, including its | Unprocessed sheep wool | |
| | hair | | |
| Cardboard/Woody | The aromatics associated with dried wood and the | Toothpicks, Water from | |
| | aromatics associated with slightly oxidized fats and | cardboard soaked for 1 hour | |
| | oils, reminiscent of a cardboard box. | | |
| Painty | The solvent aromatic associated with linseed oils and | Aroma of Linseed oil | |
| | moderately oxidized oil. | | |
| Fishy/Pondy Complex | The aroma/aromatics associated with triethylamine, | | |
| | pond water or aged fish. The general term used to | | |
| | describe fish meat, which cannot be tied to a specific | | |
| | fish by name. | | |
| Fishy | Aromatic associated with trimethylamine and old fish. | Cod liver oil capsules, | |
| | | trimethylamine, Geisha | |
| | | canned lump crab | |
| Pondy | The aromas and aromatics associated with water | Algal oil (Martek 30% DHA | |
| | containing algae, reminiscent of pond water and | oil) | |
| | aquatic tanks. | | |
| BASIC TASTES | | | |
| Sweet | The taste on the tongue stimulated by sucrose | Sucrose solution: | |
| | and other sugars, such as fructose, glucose, etc., | 2% | 2.0 |
| | and by other sweet substances, such as | 5% | 5.0 |
| | saccharin, Aspartame, and Acesulfam-K. | 10% | 10.0 |
| | | 16% | 15.0 |
| Sour | The taste on the tongue stimulated by acid, such | Citric acid solution: | |
| | as citric, malic, phosphoric, etc. | 0.05% | 2.0 |
| | | 0.08% | 5.0 |
| | | 0.15% | 10.0 |
| | | 0.20% | 15.0 |
| Salt | The taste on the tongue associated with sodium | Sodium chloride solution: | |
| | salts. | 0.2% | 2.0 |
| | | 0.35% | 5.0 |
| | | 0.5% | 8.5 |
| | | 0.55% | 10.0 |
| | | 0.7% | 15.0 |
| Bitter | The taste on the tongue associated with caffeine | Caffeine solution: | |
| | and other bitter substances, such as quinine and | 0.05% | 2.0 |
| | hop bitters. | 0.08% | 5.0 |
| | | 0.15% | 10.0 |
| | | 0.20% | 15.0 |
| CHEMICAL FEELING | | | |
| FACTOR | | | |
| Astringent | The shrinking or puckering of the tongue surface | Alum solution: | |
| | caused by substances such as tannins or alum. | 0.005% | 3.0 |
| | | 0.0066% | 5.0 |
| | | 0.01% | 9.0 |

| | | |
|---|---|---|
| Burn | A chemical feeling factor associated with high | Lemon juice, vinegar. |
| | concentration of irritants to the mucous | |
| | membranes of the oral cavity. | |

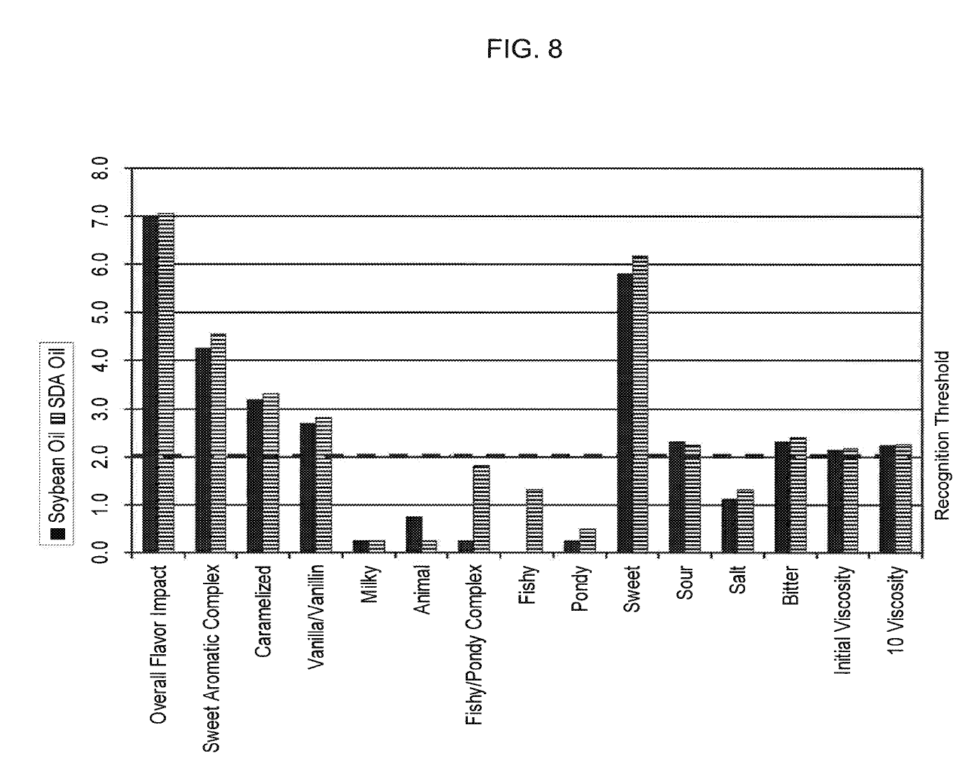

There were detectable differences between the Soybean Oil and SDA Oil clinical nutrition beverages at time 0, shown in Table 17. At time 0, the Soybean Oil clinical nutrition beverage was higher in Animal aromatics (FIG. 8). This sample also had Vitamin aromatics, Grain aromatics, Dirty aromatics, and Fishy/Pondy aromatics.

At Time 0, the SDA Oil clinical nutrition beverage was higher in Sweet Aromatic Complex, Fishy/Pondy Complex, Fishy aromatics, Sweet basic taste, Initial Viscosity, and 10 Viscosity (FIG. 8). This sample also had Vitamin aromatics and Grain aromatics.

The Fishy/Pondy aromatics in both the Soybean Oil and SDA Oil clinical nutrition beverages at Time 0 were below the recognition threshold (2.0), where consumers would not detect these aromatics in the samples.

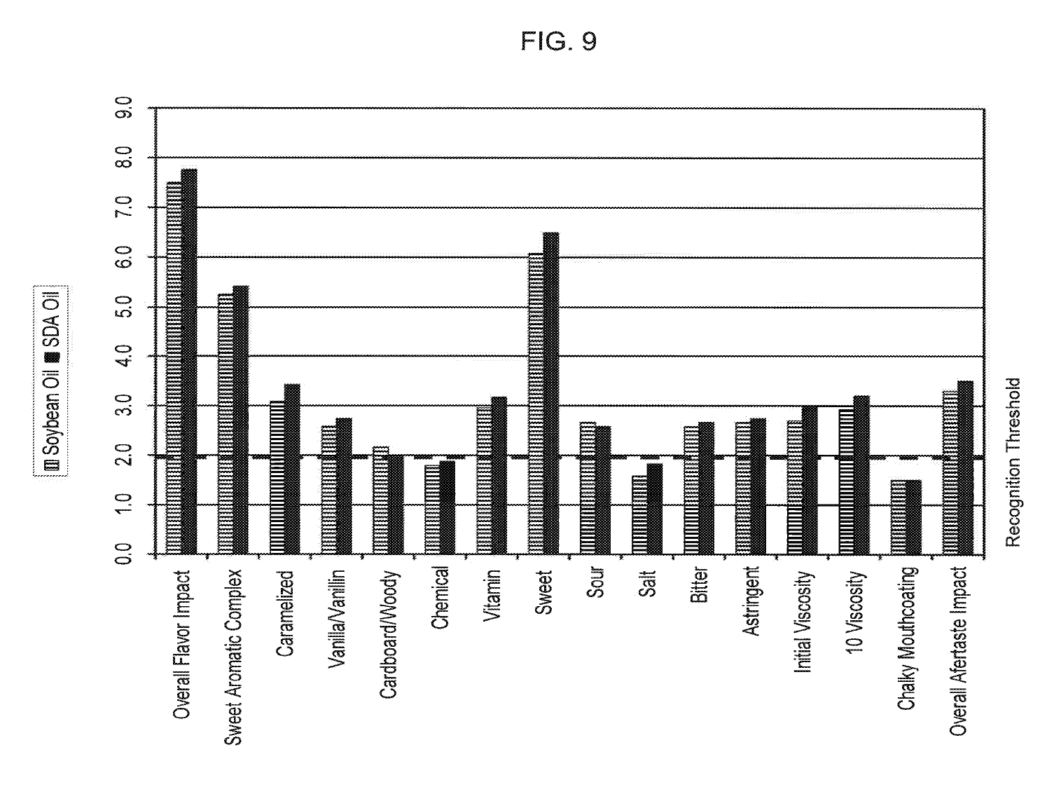

There were detectable differences between the Soybean Oil and SDA Oil clinical nutrition beverages at 4 Months, shown in Table 18. At 4 Months, the Soybean Oil clinical nutrition beverage was higher in Cardboard/Woody aromatics (FIG. 9). This sample did not have any Fishy/Pondy aromatics.

At 4 Months, the SDA Oil clinical nutrition beverage was higher in Overall Flavor Impact, Sweet Aromatic Complex, Caramelized aromatics, Vanilla/Vanillin aromatics, Sweet basic taste, Salt basic taste, Initial Viscosity, 10 Viscosity, and Overall Aftertaste (FIG. 9). This sample also did not have any Fishy/Pondy aromatics. In addition, there were no off notes at the end of shelf life in this sample, such as Painty aromatic which is an indication of oxidation.

TABLE 17
Mean Scores for Flavor, Texture, and Aftertaste Attributes at Time 0

| | Soybean Oil | SDA Oil | p value |
|---|---|---|---|
| Aromatics | | | |
| Overall Flavor Impact | 7.0 a | 7.1 a | * |
| Sweet Aromatic Complex | 4.3 b | 4.6 a | *** |
| Caramelized | 3.2 a | 3.3 a | * |
| Vanilla/Vanillin | 2.7 a | 2.8 a | * |
| Milky | 0.3 a | 0.3 a | NS |
| Dairy Fat | 0.0 | 0.0 | n/a |
| Barnyard | 0.0 | 0.0 | n/a |
| [symbol] | [symbol] [symbol] | [symbol] [symbol] | ** |
| Cardboard/Woody | 1.6 a | 1.6 a | * |
| Painty | 0.0 | 0.0 | n/a |
| Fishy/Pondy Complex | 0.3 b | 1.8 a | *** |
| Fishy | 0.0 b | 1.3 a | *** |
| Pondy | 0.3 a | 0.5 a | * |
| Other Aromatic - Vitamin | 3.1 (100%) | 3.3 (100%) | |
| Other Aromatic - Grain | 2.0 (13%) | 2.0 (13%) | |
| Other Aromatic - Dirty | 2.0 (13%) | | |
| Basic Tastes & Feeling Factors | | | |
| Sweet | 5.8 b | 6.2 a | *** |
| Sour | 2.3 a | 2.3 a | * |
| Salt | 1.1 a | 1.3 a | * |
| Bitter | 2.3 a | 2.4 a | NS |
| Astringent | 2.5 a | 2.4 a | * |
| Burn | 0.0 a | 0.3 a | * |
| Texture & Mouthfeel | | | |
| Initial Viscosity | 2.14 b | 2.17 a | ** |
| Particle Amount | 0.0 | 0.0 | n/a |
| Particle Size | 0.0 | 0.0 | n/a |
| 10 Viscosity | 2.24 b | 2.27 a | ** |
| Mixes with Saliva | 14.0 a | 14.0 a | NS |
| Chalky Mouthcoating | 1.3 a | 1.3 a | NS |
| Slick Mouthcoating | 0.0 | 0.0 | n/a |
| Tacky Mouthcoating | 0.0 | 0.0 | n/a |
| Aftertaste | | | |
| Overall Afertaste Impact | 3.1 a | 3.1 a | NS |
| Fishy Aftertaste | 0.0 a | 0.1 a | * |
| Pondy Aftertaste | 0.3 a | 0.3 a | NS |

Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

TABLE 18
Mean Scores for Flavor, Texture, and Aftertaste Attributes at
4 Months stored at 37° C.

| | Soybean Oil | SDA Oil | p value |
|---|---|---|---|
| Aromatics | | | |
| Overall Flavor Impact | 7.5 b | 7.8 a | *** |
| Sweet Aromatic Complex | 5.3 b | 5.4 a | *** |
| Caramelized | 3.1 b | 3.4 a | *** |
| Vanilla/Vanillin | 2.6 b | 2.8 a | *** |
| Milky | 1.0 a | 1.3 a | * |
| Cardboard/Woody | 2.2 a | 2.0 b | *** |
| Painty | 0.0 | 0.0 | n/a |
| Fishy/Pondy Complex | 0.0 | 0.0 | n/a |
| Fishy | 0.0 | 0.0 | n/a |
| Pondy | 0.0 | 0.0 | n/a |
| Chemical | 1.8 a | 1.9 a | NS |
| Vitamin | 3.0 a | 3.2 a | NS |
| Basic Tastes & Feeling Factors | | | |
| Sweet | 6.1 b | 6.5 a | *** |
| Sour | 2.7 a | 2.6 a | NS |
| Salt | 1.6 b | 1.8 a | ** |
| Bitter | 2.6 a | 2.7 a | * |
| Astringent | 2.7 a | 2.8 a | * |
| Texture & Mouthfeel | | | |
| Initial Viscosity | 2.7 b | 3.0 a | *** |
| 10 Viscosity | 2.9 b | 3.2 a | *** |
| Mixes with Saliva | 13.6 a | 13.6 a | NS |
| Chalky Mouthcoating | 1.5 a | 1.5 a | n/a |
| Slick Mouthcoating | 0.0 a | 0.2 a | * |
| Aftertaste | | | |
| Overall Afertaste Impact | 3.3 b | 3.5 a | *** |
| Fishy Aftertaste | 0.0 | 0.0 | n/a |
| Pondy Aftertaste | 0.0 | 0.0 | n/a |

Means in the same row followed by the same letter are not significantly different at 95% at Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

### Example 10. Sensory Acceptance of Clinical Nutrition Beverages

To evaluate sensory parity of Soybean Oil and SDA Oil, consumer acceptability based on Soybean Oil and SDA Oil was analyzed for the clinical nutrition beverages. The acceptance ratings were compared between the Soybean Oil and SDA Oil clinical nutrition beverages over shelf life. Acceptance was conducted at 4 Months at 25° C.

The samples at 4 Months were evaluated by sixty (60) consumers willing to try vanilla flavored clinical nutrition beverages. The panelists used a 9-point Hedonic acceptance scale. The Hedonic scale ranged from 1 being dislike extremely to 9 being like extremely and was used for Overall Liking, Color Liking, Flavor Liking, Mouthfeel Liking, Texture Liking, and Aftertaste Liking.

Consumers evaluated two (2) ounces of each sample that were poured into three (3) ounce cups with lid. Samples were refrigerated until served. The samples were served by sequential monadic presentation (one at a time).

The data was analyzed using the Analysis of Variance (ANOVA) to account for panelist and sample effects, with mean separations using Tukey's Significant Difference (HSD) Test.

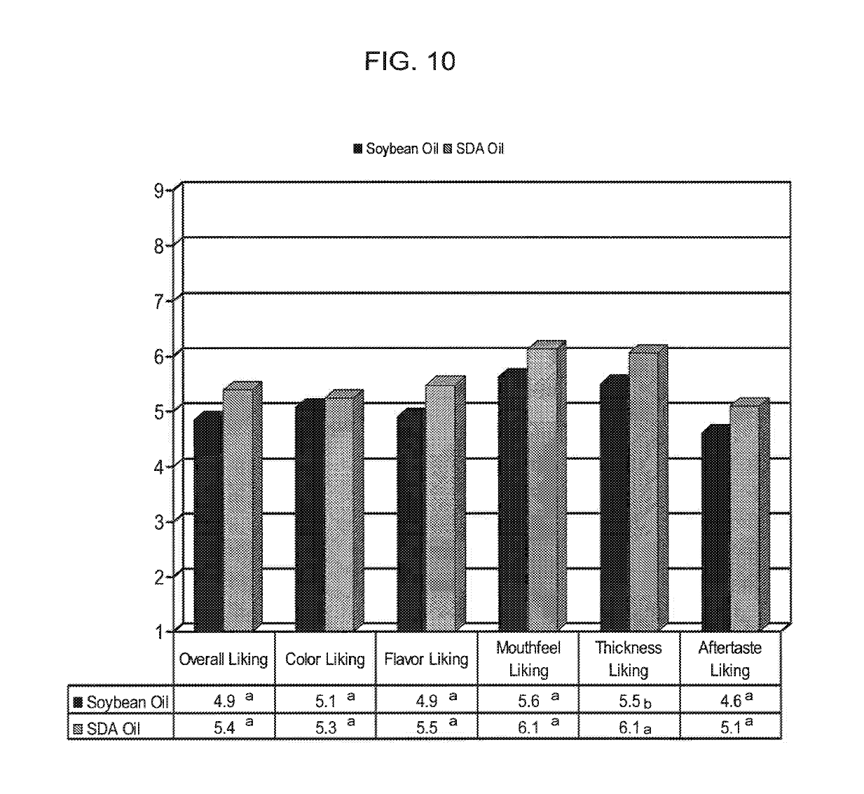

At 4 Months of being stored at 25° C., there were no significant differences between clinical nutrition beverages containing Soybean Oil and SDA Oil in Overall Liking, Color Liking, Flavor Liking, and Aftertaste Liking (FIG. 10).

Mean scores for clinical nutrition beverages containing SDA Oil were significantly higher when compared to clinical nutrition beverages containing Soybean Oil in Mouthfeel Liking and Aftertaste Liking (FIG. 10).

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

1. A beverage composition comprising an amount of a SDA enriched soybean oil.

2. The beverage composition of claim 1 wherein the beverage composition further comprises a stabilizing agent.

3. The beverage composition of claim 2, wherein the stabilizing agent is a phospholipid or combination of phospholipids.

4. The beverage composition of claim 3, wherein the stabilizing agent is selected from the group consisting of lecithin, phosphatidylcholine, phosphatidylethanolamine, phosphatidylinositol, phosphatidylserine, diphosphatidylglycerol, dipalmitoylphosphatidylcholine, 1-stearyoyl-2-myristoylphosphatidylcholine, or 1-palmitoyl-2-linoleoylethanolamine, and mixtures thereof.

5. The beverage composition of claim 2, wherein the stabilizing agent ranges between about 0.1% to about 65% by weight of the SDA enriched soybean oil.

6. The beverage composition of claim 1 wherein the beverage composition further comprises a protein.

7. The beverage composition of claim 6 wherein the protein is selected from the group consisting of soy protein, pea protein, milk protein, rice protein, collagen, and combinations thereof.

8. The beverage composition of claim 1, wherein the beverage composition is selected from the group consisting of a meal replacement drink, a protein shake, a dairy based drink, a smoothie, a coffee-based beverage, a nutritional supplement beverage, a clinical nutrition liquid, a weight management beverage, a tea based beverage, chai, an alcoholic beverage, a sport nutrition beverage, an energy drink, a dairy beverage, a substantially clear beverage, a juice beverage, a soy beverage, bottled water, a fruit flavored beverage, a carbonated beverage, an isotonic beverage, a ready-to-drink acidic beverage, a ready-to-drink neutral beverage, and combinations thereof.

9. The beverage composition of claim 1, wherein the SDA enriched soybean oil is selected from the group consisting of SDA enriched soybean oil, SDA enriched non-defatted soy flour, and combinations thereof.

10. The beverage composition of claim 1, wherein the beverage composition further comprises a secondary antioxidant selected from the group consisting of ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., lonox 100), 2,4-(tris-3′, 5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof.

11. The beverage composition of claim 1, wherein the beverage composition comprises a secondary antioxidant selected from the group consisting of tocopherols, ascorbyl palmitate, ascorbic acid, rosemary extract, green tea extract, and combinations thereof.

12. The beverage composition of claim 1, wherein the sensory characteristics of the beverage composition are comparable to the sensory characteristics of a conventional beverage.

13. A method of using SDA enriched soybean oil to form a beverage composition, wherein the method comprises:
a. adding SDA enriched soybean oil to a beverage mix; and, b. blending the SDA enriched soybean oil and beverage mix to form a beverage composition.

14. The method of claim 13 wherein the SDA enriched soybean oil comprises between about 1% to about 100% of fat or oil required in the beverage composition.

15. The method of claim 13 wherein a stabilizing agent is added to the beverage composition.

16. The method of claim 13, wherein the secondary antioxidant is added in an amount ranging between 0.001% and about 5% by weight of the SDA enriched soybean oil.
